(19) United States
(12) Patent Application Publication
(10) Pub. No.: US 2003/0004861 A1
(43) Pub. Date: Jan. 2, 2003

(54) Electronically facilitating real estate transfer

(76) Inventors: John Thomas Amend, Dallas, TX (US); Jack Allen Seifrick, Dallas, TX (US); David G. Gordon, Dallas, TX (US)

Correspondence Address: JENKENS & GILCHRIST, P.C, 3200 Fountain Place, 1445 Ross Avenue, Dallas, TX, 75202-2799, US

(21) Appl. No.: 10/136,464

(22) Filed: May 1, 2002

Related U.S. Application Data
(63) Continuation-in-part of application No. 09/724,710, filed on Nov. 28, 2000.
(60) Provisional application No. 60/287,996, filed on May 1, 2001.
(60) Provisional application No. 60/242,212, filed on Oct. 20, 2000.

(51) Int. Cl. G06F 17/60

(52) U.S. Cl. 705/37

(57) ABSTRACT

A tenant-centric paradigm is applied to the real estate selection, acquisition, and outfitting process. Also, an online information management and exchange mechanism, a parallel approach to the process, and a demand-focused scheme may be employed to facilitate the linking of would-be tenants to the real estate of landlords. Tenants are empowered by enabling them to submit project specifications, which include desired characteristics of real estate, outfitting parameters, and a move-in date, which may be in the future. These project specifications may be combined into a real estate demand (aggregation) database, which may be accessed by landlords. Alternatively, a project specification may be submitted directly to landlords, which respond with proposals. These proposals may be combined into an ad hoc real estate supply database to service the tenant that created the project specification. Other embodiments may include, for example, on-line collaboration, information sharing, and document hosting.

### REFERENCE TO PRIOR APPLICATIONS

The present application for patent claims priority from and hereby incorporates by reference the subject matter disclosed in U.S. patent application Ser. No. 09/724,710, filed on Nov. 28, 2000, which claims the benefit of priority from U.S. Provisional Application for Patent Serial No. 60/242,212, filed Oct. 20, 2000. In addition, this application hereby incorporates by reference and claims the benefit of priority from U.S. Provisional Application for Patent Serial No. 60/287,996, filed May 1, 2001.

### BACKGROUND OF THE INVENTION

1. Technical Field of the Invention

The present invention relates in general to the field of real estate exchange/market(s) and the provisioning thereof, and in particular, by way of example but not limitation, to creating and implementing an efficient and expeditious mechanism for linking tenants with real estate that matches their requested specifications as well as outfitting such real estate with appropriate accouterments.

2. Description of Related Art

The real estate industry exists, ostensibly, so as to enable would-be tenants to secure leaseholds on real estate owned by landlords (or to purchase real estate from owners). Unfortunately, the current real estate industry is replete with inefficiencies and “middlemen” that together result in unnecessarily high costs and lengthy delays.

Referring now to FIG. 1, an exemplary purpose for the real estate industry is illustrated generally at 100. The real estate industry 105, in at least one regard, is intended to enable real estate 110 to be linked to one or more tenants 115. Tenants 115 may include, for example, corporations, partnerships, individuals, governmental entities, charitable institutions, etc. Real estate 110 may include, for example, high, medium, and low rise structures; flexible buildings suitable for, e.g., research and design; industrial complexes and properties; land (e.g., for building to suit); a portion thereof (e.g., a floor, a quadrant, etc.); etc. The tenants 115, as represented by respective real estate departments or liaisons, for example, determine desired characteristics of real estate to be acquired for lease, purchase, etc. The real estate industry 105 endeavors to link a tenant 115 to a parcel of real estate 110 by matching the real estate desires (or at least the minimum requirements) of the tenant 115 to a piece of real estate 110 at an acceptable cost.

Referring now to FIG. 2, a first conventional real estate linking paradigm is illustrated generally at 200. This traditional paradigm 200 includes tenants 115 that are eventually linked to satisfactory real estate 110. Each piece of real estate 110 is owned, operated, and/or managed by a landlord 205. In most, especially commercial, real estate environments, each landlord 205 is represented by a landlord's broker (BL) 210 while each tenant 115 is represented by a tenant's broker (B_{T}) 215. In this traditional paradigm 200, the power and control is (intentionally or inadvertently) vested in various brokers, who control both the information relevant to any real estate deal as well as the flow of such information and the process undertaken to consummate the transaction, instead of the customer (e.g., the tenant 115) or even the purveyor (e.g., the landlord 205). As indicated by the communication arrows 220, the likelihood of a particular tenant 115 having even the opportunity to pursue a particular piece of real estate 110 is at least partially dependent on whether the respective brokers 210 and 215 have knowledge (i) of each other's existence and business or (ii) of a particular locale or access to a particular proprietary database, which may not be current in any event. The information controlled by the middlemen, the brokers 210 and 215, includes not only the factual information associated with the attributes of real estate 110 and the desires of the tenant 115, but it also includes more intangible knowledge such as what each party will actually accept in a deal. This distribution of intangible knowledge may, if not properly shared and utilized by the brokers 210 and 215, hinder the completion of a deal, or, on the other hand, it may result in an agreement that is sub-optimal, especially for the tenant 115.

Furthermore, due to the nature of the broker-to-broker interplay, not only is a portion of any profit from the transaction absorbed by middlemen, but there is a resistance to being able to pursue multiple deals simultaneously, especially if multiple landlord brokers 210 must be involved in order to pursue the various alternative pieces of real estate 110. Moreover, as will be explained in greater detail hereinbelow with reference to FIG. 4, the organization and inertia of the traditional real estate industry extends the period of time a tenant 115 must endure before a piece of real estate 110 is ready for possession and use because the traditional real estate industry adheres to a conventional serialized approach. This conventional serialized approach to securing a piece of real estate 110 and subsequently, and only subsequently, outfitting the real estate 110 lengthens the period of time between when a tenant 115 determines the need and appropriateness for expansion and when the tenant 115 may actually expand into new or larger facilities. This lengthened time period is unfortunately too long to meet the needs of today's businesses, especially those that must compete at “Internet speed”.

Referring now to FIG. 3, a second, electronically-based conventional real estate linking paradigm is illustrated generally at 300. Each landlord 205 that has real estate 110 available may enter relevant data regarding the real estate 110 into a database of real estate that is currently available 305. Access to the database of real estate that is currently available 305 is typically provided through an Internet site and server 310 via the Internet 315. A tenant 115 inputs a query that includes a minimal amount of information regarding desired real estate traits (i.e., city, area of town, square footage, and property type) using a terminal 320 (i.e., a computer with Internet access). The query is sent from the terminal 320, over the Internet 315, and then to the Internet site and server 310. The Internet site and server 310 submits the query to the database of real estate that is currently available 305. Electronic real estate listings that match the minimal information input for the query are extracted from the database of real estate that is currently available 305 and forwarded for display at the terminal 320 for review by the tenant 115. The tenant 115 may thereafter select one or more of the displayed properties for further consideration.

In this first-generation Internet paradigm 300, the power and control is vested primarily in the database of real estate that is currently available 305 and the Internet site and server 310. However, some control, and hence some power, is also vested in the landlords 205 inasmuch as the landlords are empowered to present their real estate to tenants 115 without necessarily relying on one or more brokers. However, the customer in the real estate environment, the tenant 115, still has no direct control of the real estate selection and acquisition process. Another drawback to this approach is that the data in the database of real estate that is currently available 305 rapidly and frequently becomes outdated. The tenant 115 therefore has little certainty, and definitely no guarantee, as to whether or not any particular real estate forwarded to the terminal 320 is still available. Moreover, the tenant is unable to plan for the future inasmuch as the data in the database of real estate that is currently available 305 only includes listings of real estate that is presently on the market.

Referring now to FIG. 4, a conventional real estate acquisition and outfitting process is illustrated generally at 400. The time line 400 indicates a project initiation time 405 and a project completion time 410. The duration between the project initiation time 405 and the project completion time 410 is typically 18-22 months using the conventional linear approach. (It should be noted that the various phases in the time line 400 are not necessarily drawn to relative scales with respect to each other.) An initial real estate phase 415 overlaps an analysis phase 420 only slightly. While a due diligence phase 425 is frequently started during the analysis phase 420, subsequent design sub-phases of programming 430 and development 435 are only started and completed in a serial fashion. Furthermore, a bidding/estimation/value engineering phase 440, a construction phase 445, and a relocation phase 450 are also carried out in a serial manner after the development design sub-phase 435 is completed. Each of the bidding/estimation/value engineering phase 440, the construction phase 445, and the relocation phase 450 is only started after the respective previous phase is completed, which causes the above-noted completion time of 18-22 months. As noted hereinabove, such a time period is too long to meet the needs of today's businesses, especially those that must compete at “Internet speed”.

In short, conventional real estate paradigms have heretofore failed to empower the tenant-customer to control the real estate selection, acquisition, and outfitting process. Furthermore, the process to which the tenant-customer is subjected is fraught with delays intrinsic to the traditional serialized approach to this process as well as frustrations from other inherent inefficiencies.

### SUMMARY OF THE INVENTION

The deficiencies of existing paradigms and approaches are overcome by the methods, systems, arrangements, and electronic transactions of the present invention. For example, as heretofore unrecognized, it would be beneficial to institute a tenant-centric paradigm for the real estate selection, acquisition, and outfitting process. In fact, it would also be beneficial if this tenant-centric paradigm involved an online information management and exchange mechanism, a parallel approach to the outfitting process, and a demand-focused selection and acquisition scheme.

The present invention in various embodiments is directed to real estate exchange, real estate markets, etc. In certain embodiment (s), a tenant-centric paradigm enables the customer in the real estate environment to control, guide, and drive the real estate selection, acquisition, and outfitting process. As a result, the likelihood of a would- be tenant securing an optimal piece of real estate in a timely manner is significantly increased. Furthermore, costs can be reduced (i) as middlemen may be optionally excluded from the process, (ii) as information is made available to the tenant-customer, (iii) as traditional delays are reduced or eliminated, (iv) as traditional “dead ends” are avoided, etc. Moreover, the time from when a determination by the tenant-customer of desired real estate characteristics is made to a time when such desired characteristics are made available for move-in and utilization is significantly reduced by automating the real estate acquisition and outfitting process as well as by orchestrating the performance of certain phases in parallel.

In certain embodiment (s), a demand-pull type market for real estate is created using, for example, an online mechanism. The demand-pull type market may entail a database that includes, for example, data items associated with a collection of real estate characteristics (e.g., as part of an overall project requirements specification) desired by a tenant either currently or in the future. This list of characteristics may be associated with, inter alia, a time, which may be in the future, at which the desired characteristics will be needed.

This database, in certain embodiment(s), may be accessed and searched by landlords so as to enable them to determine whether there are any tenant-customers whose real estate needs they may be able to meet. After determining a target project requirements specification that they may be able to meet, the various landlords may thereafter bid in which they submit (e.g., in an on-line, standardized proposal format) to the tenant-customer their best offer to satisfy or meet the project requirement specifications, and other intangibles, of the tenant-customer. This database, in accordance with certain embodiment(s) of the present invention, may therefore also be instrumental in producing a demand-pull type marketplace for real estate.

Also in certain embodiment(s), project requirement specifications of a would-be tenant may be compared to a database that includes entries directed to a real estate supply of various landlords. When one or more successful matches are determined, the corresponding landlords are notified so that they may, at their option, prepare a bid proposal to the would-be tenant. Alternatively, the matches that result from the comparison may be returned to the would-be tenant for analysis and review. The review may entail access to detailed information regarding the real estate matches, including, e.g., the associated amenities and a virtual on-line tour. The tenant consequently has the ability to narrow the list of matches to a preferred list. Landlords corresponding to the matches on the preferred list may subsequently be sent requests for a proposal (RFPs). Such proposals, which advantageously may be required to adhere to a standardized format for the convenience of the tenant-customer, that are produced by landlords on the preferred list may be analyzed and/or considered.

Also in certain embodiment(s), landlords (i) may only be given access to the aforementioned tenant-centric demand database, (ii) may only have their corresponding entries in the real estate supply database be compared to project requirement specifications, and/or (iii) may only have their corresponding entries in the real estate supply database available for direct searching or perusal by others (e.g., would-be tenant-customers) if and only if the landlord has updated all such corresponding entries in the real estate supply database within a prescribed period of time and/or at least once during each prescribed interval.

Also in certain embodiment(s), a quasi-spot market is created to service a particular demand-driven transaction. A would-be tenant provides a project requirements specification for a desired real estate transaction. Pertinent aspects of the information in the project requirements specification are extracted and provided to multiple landlords for their consideration. Each of the multiple landlords may review the pertinent aspects of the desired real estate transaction to determine whether or not they have the real estate resources to meet the specified requirements. For those landlords that decide in the affirmative, data related to relevant pieces of real estate is provided. The data from various responding landlords is provided by them and combined into an ad hoc real estate supply database for use in servicing the particular desired real estate transaction.

Also in certain embodiment(s), different phases from conception and specification of project requirements to final completion of the outfitting process are overlapped using, for example, an online mechanism. For instance, project requirement specifications from the would-be tenant may be forwarded to appropriate expertise for the outfitting process. This expertise may include, for example, companies equipped to handle design, engineering, information technology, and/or other build-out aspects for readying a space for ultimate move-in.

Also in certain embodiment(s), landlords may be permitted to access (in addition to general entries in a real estate demand database) entries corresponding to projects/deals that are in the process of being completed and/or agreed to. In such cases, landlords have the option of requesting to be included in the list of possible real estate providers by submitting an unsolicited response to a request for information (RFI), which typically has less information than a request for proposal (RFP). The landlords may be given the opportunity to review on-going projects/deals as an optional part of certain embodiment(s) that involve on-line collaboration between various parties in the real estate selection, acquisition, and outfitting process. This on-line collaboration may further facilitate a parallel approach to the process in which various phases are advantageously overlapped in time.

Also in certain embodiment(s), document (e.g., real estate related document) hosting on-line enables near any-time, anywhere access to documents being used in the real estate selection, acquisition, and outfitting process. Benefits of the document hosting embodiment(s) may be synergistically increased by combining them with on-line collaboration embodiment(s). In further embodiment(s), lease administration may be seamlessly integrated with on-line mechanisms in accordance with the present invention. Lease administration embodiment(s) may be combined with, for example, real estate demand (aggregation) database embodiment(s) by presently, e.g., “posting” leases that will expire in the future at the behest of the landlord or tenant. In still further embodiment (s), access to various information collected by the on-line mechanism may be exchanged for value with other parties both during actual individual projects/deals/transactions and as statistical summaries after effectuating multiple such projects/deals/transactions. In yet still further embodiment(s), agreements (e.g., those that are real estate-related) may be created on-line by selecting or deleting various provisions from a collection of provisions.

The above-described and other features/embodiments of the present invention are explained in detail hereinafter with reference to the illustrative examples shown in the accompanying drawings. It should be noted that those skilled in the art will appreciate that the described embodiments are provided for purposes of illustration and understanding and that numerous equivalent embodiments are contemplated herein. Also, it should be understood that the various embodiments of the present invention as described herein may be combined to create still other embodiments.

### BRIEF DESCRIPTION OF THE DRAWINGS

A more complete understanding of the methods, systems, arrangements, and electronic transactions of the present invention may be had by reference to the following detailed description when taken in conjunction with the accompanying drawings wherein:

FIG. 1 illustrates an exemplary purpose for the real estate industry;

FIG. 2 illustrates a first conventional real estate linking paradigm;

FIG. 3 illustrates a second, electronically-based conventional real estate linking paradigm;

FIG. 4 illustrates a conventional real estate acquisition and outfitting process;

FIG. 5 illustrates an exemplary, tenant-centric paradigm for the real estate industry in accordance with the present invention;

FIG. 6 illustrates an exemplary real estate linking scheme in accordance with the present invention;

FIGS. 7A and 7B illustrate an exemplary method in flowchart form for linking tenants to real estate in accordance with the present invention;

FIG. 8 illustrates certain aspects of an exemplary on- line mechanism in accordance with the present invention;

FIG. 9 illustrates an exemplary real estate demand database in accordance with the present invention;

FIG. 10 illustrates an exemplary on-line mechanism for creating an ad hoc real estate supply database in accordance with the present invention;

FIG. 11 illustrates an exemplary method in flowchart form for creating an ad hoc real estate supply database in accordance with the present invention;

FIG. 12 illustrates an exemplary real estate acquisition and outfitting process in accordance with the present invention;

FIG. 13 illustrates an exemplary method in flowchart form for participating in an on-line collaboration in accordance with the present invention;

FIG. 14 illustrates an exemplary method in flowchart form of an alternative embodiment for creating an ad hoc real estate supply database in accordance with the present invention;

FIG. 15 illustrates an exemplary method in flowchart form of an alternative embodiment for linking tenants to real estate in accordance with the present invention; and

FIG. 16 illustrates an exemplary method in flowchart form for lease administration in accordance with the present invention.

### DETAILED DESCRIPTION OF THE DRAWINGS

In the following description, for purposes of explanation and not limitation, specific details are set forth, such as particular computer systems, flow charts, logic modules (implemented in, for example, software, hardware, firmware, some combination thereof, etc.), techniques, etc. in order to provide a thorough understanding of the invention. However, it will be apparent to one of ordinary skill in the art that the present invention may be practiced in other embodiments that depart from these specific details.

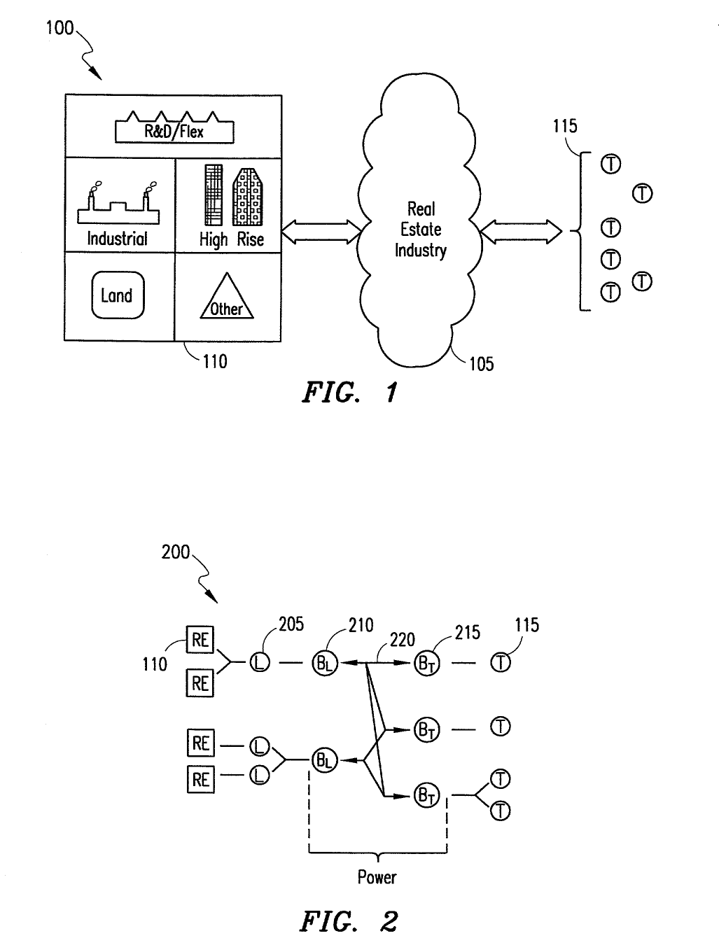

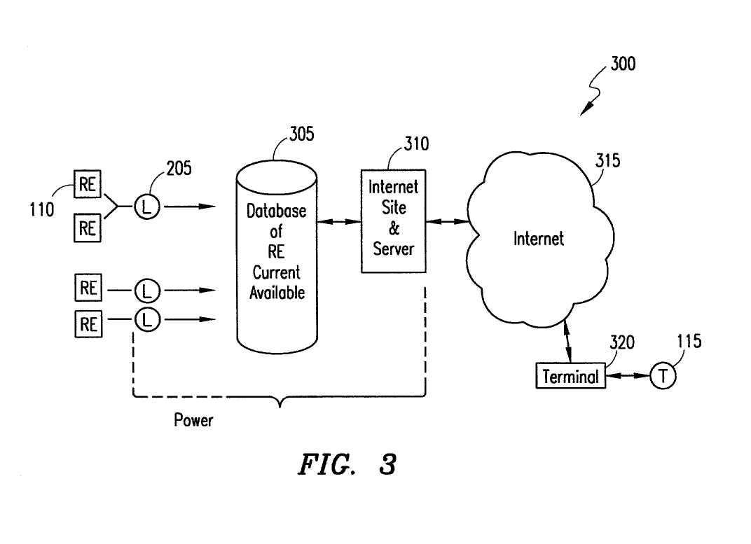

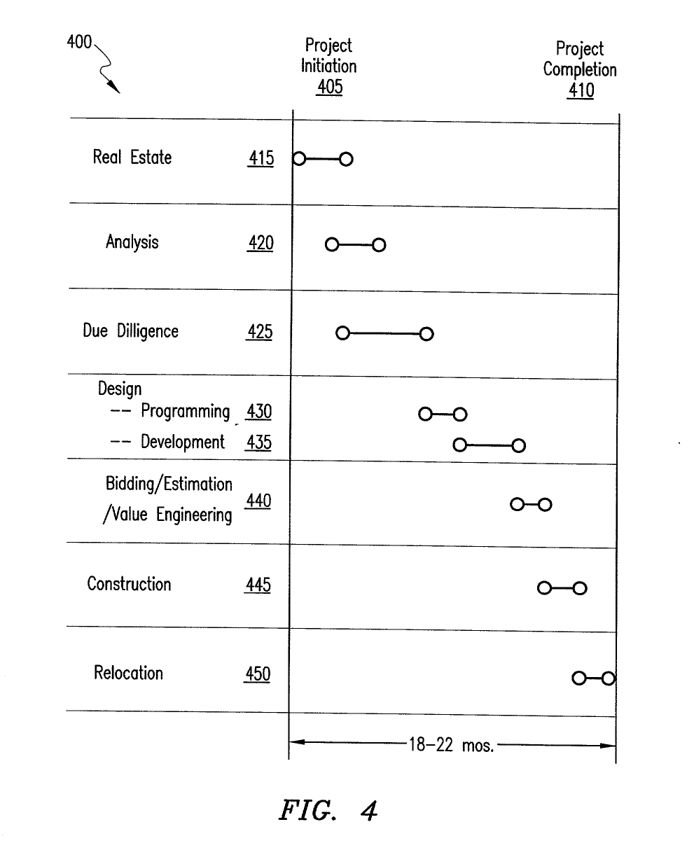

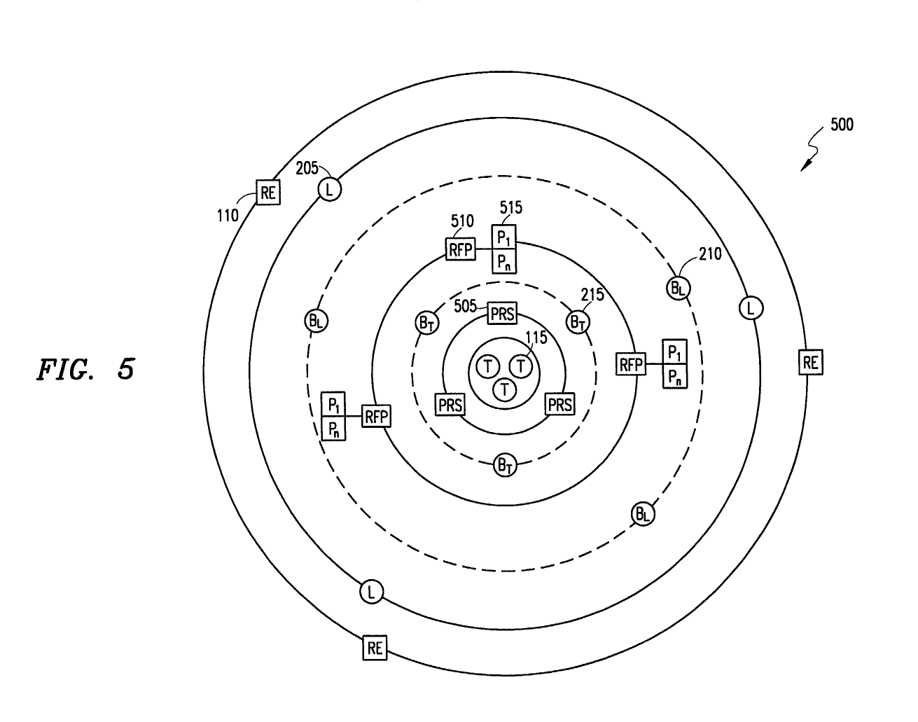

A preferred embodiment of the present invention and its advantages are best understood by referring to FIGS. 1-16 of the drawings, like numerals being used for like and corresponding parts of the various drawings.

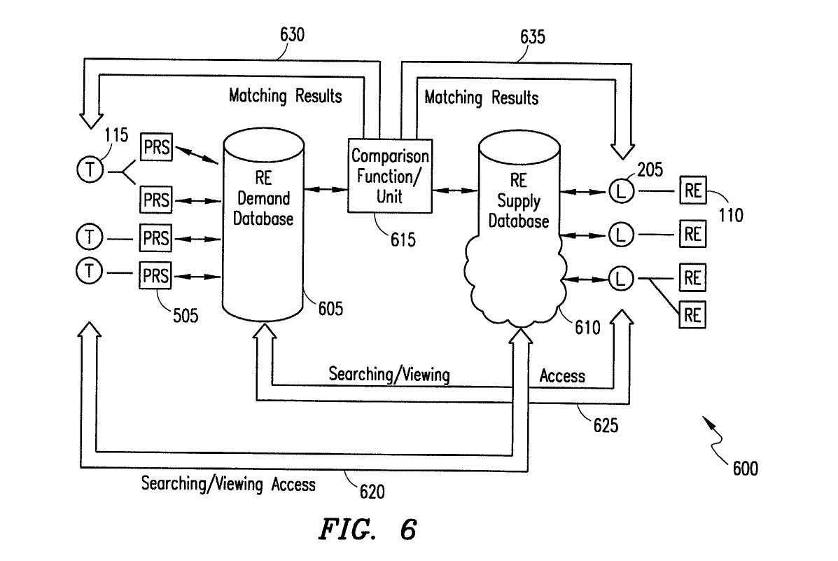

Referring now to FIG. 5, an exemplary, tenant-centric paradigm for the real estate industry in accordance with the present invention, is illustrated generally at 500. In contradistinction to existing paradigms of the real estate industry, the principles of the present invention advantageously adopt a tenant-centric paradigm. The tenant is the central focus of the structure, management, and work flow in this tenant-centric paradigm. In the organizational diagram 500, a set of concentric circles have at their center tenants 115. The remainder of the real estate industry revolves around the tenants 115 in order to best meet their needs. The tenants 115 initiate a real estate inquiry by completing a project requirements specification (PRS) 505. The PRS 505 may be input, for example, using an on-line mechanism. Each PRS 505 includes data related to the identity, needs, and desires of the would-be tenant 115. This data includes, for example, client name, date inquiry initiated, date real estate desired, target square footage, building class, parking requirements, generic special requirements, general manager (e.g., for construction), broker, design firm contact, all project contacts, move-in date needed, etc.

As indicated by the dashed-line circle for the tenants' brokers 215, the tenants' brokers may optionally be included in the process. While not required in accordance with certain embodiment(s) of the present invention, a would-be tenant may feel more comfortable using a broker that is familiar with the targeted locale and/or may have a history with a broker that understands the would-be tenant's preferences. The on-line mechanism may be employed to convert the PRS 505 to a request for proposal (RFP) 510. An electronic transmission is sent to each of multiple landlords 205, each of which is associated with one or more pieces of real estate 110. The electronic transmission may be sent to the multiple landlords 205 using, for example, an electronic mail (e.g., e-mail) format. The electronic transmission notifies the landlords 205 of the RFP 510 and may optionally provide instructions and/or directions (e.g., one or more links to a web site page or pages) for and/or to accessing and viewing/retrieving the RFP 510. Alternatively, the RFP 510 may be sent directly to each of the multiple landlords using, for example, an electronic transmission.

As indicated by the dashed-line circle for the landlords' brokers 210, the landlords' brokers may optionally be included in the process. While not required in accordance with certain embodiment(s) of the present invention, landlords may elect to rely on a broker to facilitate and streamline communications. Each landlord 205 that receives the RFP 510 decides whether or not to respond thereto. Those landlords 205 that are interested in providing a solution to the would-be tenant's 115 real estate needs prepare a proposal (e.g., proposals P₁ . . . Pₙ) 515. The would-be tenant 115 that originally prepared the PRS 505 is notified of the one or more proposals 515 using, for example, an electronic transmission (e.g., electronic mail, etc.). The electronic transmission may optionally provide instructions and/or directions (e.g., one or more links to a web site page or pages) for and/or to accessing and viewing/retrieving the one or more proposals 515. Alternatively, the one or more proposals 515 may be sent directly to the would-be tenant 115 using, for example, an electronic transmission. The proposals 515 may also be prepared and forwarded by the landlords 205 using an on-line mechanism. The PRS 505, the RFP 510, the proposals 515, etc. may be formatted in a standardized manner.

In accordance with an embodiment of the present invention, the system may combine information from other (e.g., earlier) parts of the transaction/transfer process into a single file. For example, proposal and financial information for all of the buildings selected by the would-be tenant as “finalists” can be combined, with their respective information from the RFI/RFP dialogue and exchange(s), into the single file using an automated process. The file may then be converted into a more standard format, such as MS Word and WordPerfect. Advantageously, the converted file format may then be easily modified and fine-tuned for final presentation, or for other manipulation. Notably, when a transaction is near culmination (or after), a summary document with final terms and conditions can be created by the system. The information in the summary document may then be provided to a lease management/administration program. For example, in addition to the terms and conditions, contact information and reminders (e.g., those derived from the terms and conditions) may be imported to the lease management/administration easily and automatically because the lease transaction side of the system may be coupled to the lease management/administration “side,” although they may actually be separate programs.

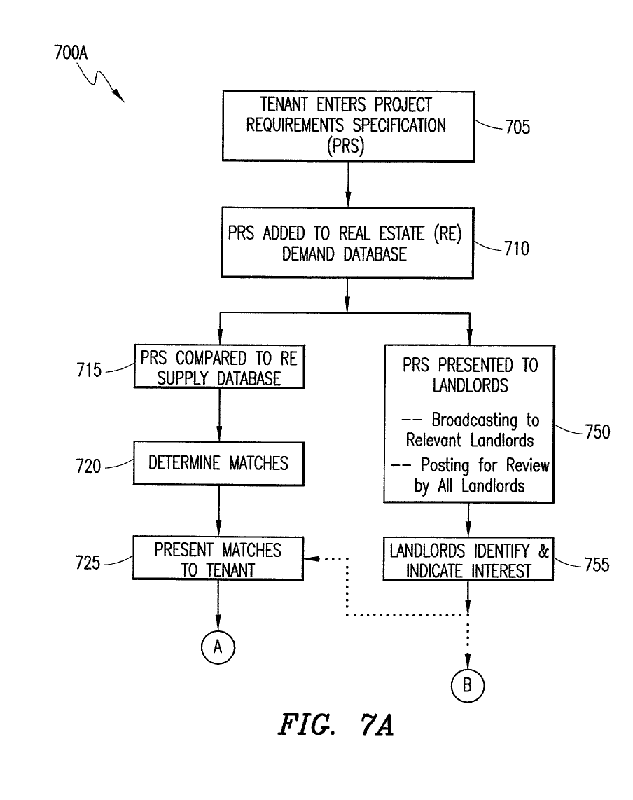

Referring now to FIG. 6, an exemplary real estate linking scheme in accordance with the present invention is illustrated generally at 600. The real estate linking scheme 600 may include a real estate demand database (or, more generally, a data structure) 605 and a real estate supply database (or, more generally, a data structure) 610. A would-be tenant 115 may complete a PRS 505 using, for example, an on-line mechanism. In other words, the would-be tenant 115 may fill out a form on a web page and then submit the form to a centralized or distributed repository (e.g., a web site). It should be noted that other means to enter the PRS 505 information into an electronic format may alternatively be used. After many (or at least two) PRSs 505 have been received, they may be amalgamated into the real estate demand database 605. The real estate demand database 605 thus serves to aggregate both present and future real estate demand.

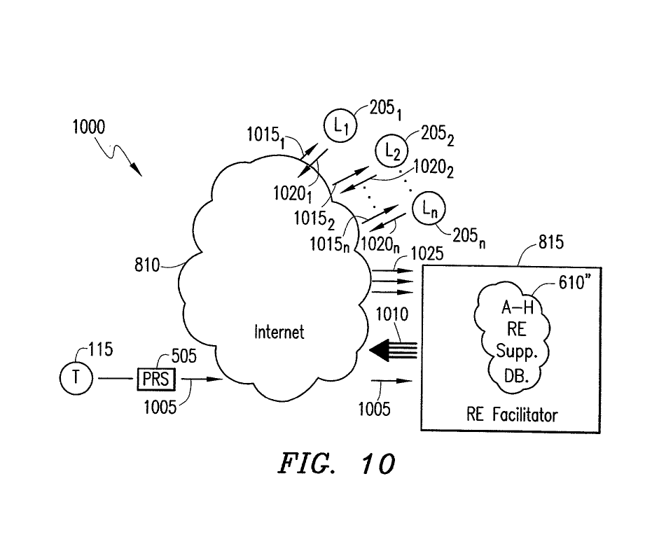

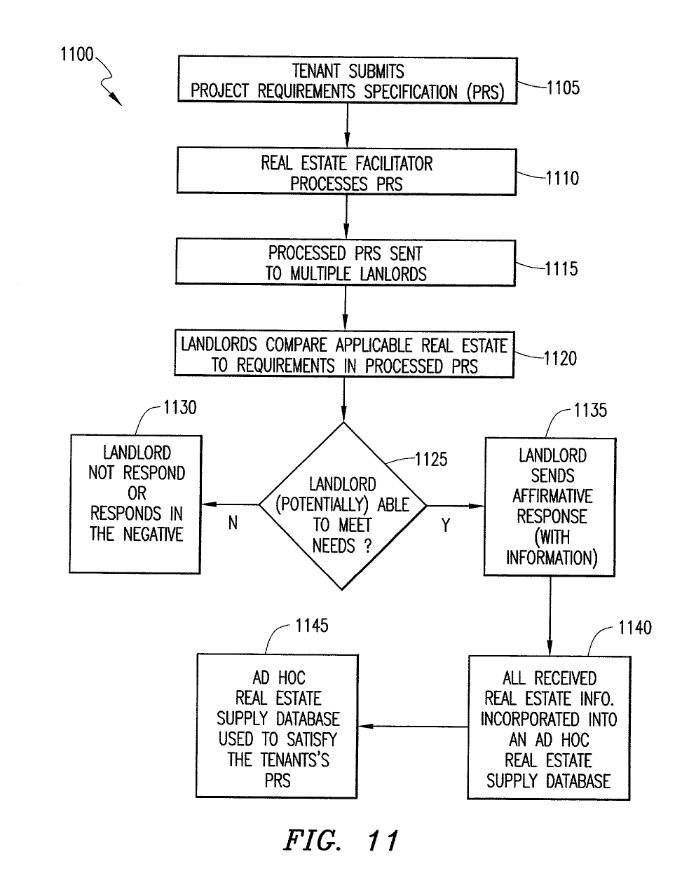

Landlords 205, each of which is associated with one or more pieces of real estate 110, prepare an entry for each piece of real estate 110 that they want entered into the real estate supply database 610. Each entry includes details regarding real estate that is or will be available, such as landlord identity, square footage, availability time frame, building type, building location, amenities offered, number of parking spaces, etc. A landlord 205 may complete such an entry using, for example, a on-line mechanism. In other words, the landlord 205 may fill out a form on a web page and then submit the form to the web site, for example. It should be noted that other means to convert entry information into an electronic format may alternatively be used. After many (or at least two) such real estate entries have been received, they may be amalgamated into the real estate supply database 610. The real estate supply database 610 thus serves to aggregate both present and future real estate supply. As indicated by the “cloud-like” appearance of the lower portion of the illustration of the real estate supply database 610, at least a portion of the real estate supply database 610 may be in flux and/or be built/established on an ad hoc basis. An ad hoc real estate supply database may be formed of entries that are provided by landlords 205 in response to a particular PRS 505. Consequently, an ad hoc real estate supply database is formed responsive to the needs of an individual would-be tenant 115 and by landlords 205 that are interested in meeting those needs. Such an ad hoc real estate supply database is described further hereinbelow with particular references to FIGS. 10 and 11.

In an alternative embodiment, the real estate supply database 610 can be populated using information on known real estate in a geographic area, regardless of whether there is any currently known availability in such real estate. In this embodiment, the real estate supply database 610 can include base building data that rarely changes, such as the size of the building, the location, the year in which the building was built, who represents the building (i.e., leasing agent), and other permanent or semi-permanent facts about the building.

Once the real estate supply database 610 has been established, searching and viewing access 620 may be provided to would-be tenants 115 via, for example, an on-line mechanism such as a web site. In accordance with certain embodiment(s) of the present invention, landlords 205 may advantageously be provided with searching, viewing, etc. access 625 to the real estate demand database 605. This access may be accomplished, for example, via an on-line mechanism such as a web site. This access enables landlords 205 to analyze the current and future needs of various tenants 115 and to attempt to meet them. As a result, multiple landlords 205 are likely to be exposed to a given tenant's 115 PRS 505, which exposure increases the likelihood that the tenant 115 will receive multiple competing proposals 515.

In accordance with certain embodiment(s) of the present invention, a comparison function/unit/software program 615 may access both the real estate demand database 605 and the real estate supply database 610 in order to find matches between the PRSs 505 of the real estate demand database 605 and the entries from landlords 205 of the real estate supply database 610. Entries from the real estate supply database 610 that appear to meet the requirements enumerated in a particular PRS 505 of the real estate demand database 605 may be forwarded as matching results 630 to the corresponding would-be tenant 115. These matching results 630 may be forwarded, for example, in a standardized electronic format via e-mail. The would-be tenant 115 may then investigate the real estate corresponding to the matching entries before selecting a number of entries for further consideration. The further consideration may include, for example, sending RFPs 510 to the landlords 205 that correspond to the selected entries. The comparison feature 615 may also compare each PRS 505 of the real estate demand database 605 to a particular entry of the real estate supply database 610. The PRSs 505 that appear to be satisfiable by the particular entry are forwarded as matching results 635 to the corresponding landlord 205. The matching results 635 may be forwarded, for example, in a standardized electronic format via e-mail. The landlord 205 may review the received PRSs 505 and submit a proposal to each would-be tenant 115 that had entered a PRS 505 for which the landlord 205 is able to satisfy the requirements.

In cases where the real estate supply database 610 includes all or substantially all of the potential real estate in an area, potential tenants can identify real estate that might meet the criteria in the PRS 505 even before the real estate is publicly known to have availability and/or before the real estate supply database 610 is updated to indicate availability. The tenant can then forward the PRS 505 to the landlord 205 that corresponds to the identified real estate. This increases the number of matches for potential space and can provide the potential tenant with a head-start on other potential tenants in cases where future availability is not publicly known.

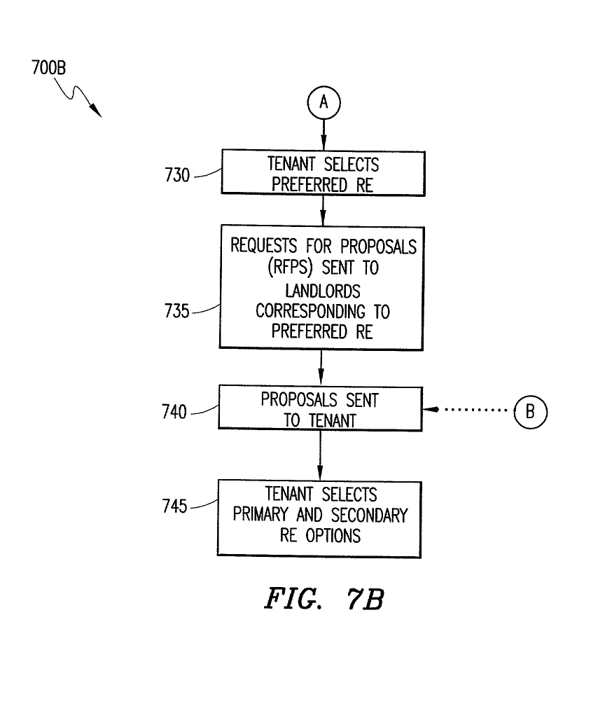

Referring now to FIGS. 7A and 7B, an exemplary method in flowchart form for linking tenants to real estate in accordance with the present invention is illustrated generally at 700A and 700B, respectively. In accordance with the tenant-centric paradigm and demand-focused scheme of the present invention, the prospective tenant enters a project requirements specification (PRS) (step 705). The PRS may be entered using, for example, a web site form. The PRS may be added to a real estate demand database (step 710). Such a real estate demand database may be composed of a data structure with multiple PRSs indexed and linked appropriately in order to facilitate searching, access, retrieval, etc. The entered PRS may be compared to each entry in a real estate supply database (step 715). The comparison will ordinarily result in one or more matches (step 720). In this context, a match may imply that the entry of the real estate supply database holds or indicates a potential to meet the requirements set forth in the PRS. The one or more matches may then be presented to the would-be tenant that entered the PRS (step 725).

These one or more matches may be presented to the would-be tenant via, for example, e-mail with links to web site locations that include further descriptions and/or the ability to take virtual tours of the real estate. The matching results can also be presented in the form of a report that allows corresponding fields from different matching entries to be easily compared, thereby facilitating the tenant's selection and ranking process. The tenant reviews the presented entries and selects one or more entries that correspond to potentially desirable real estate (e.g., preferred real estate) (step 730). Requests for proposals (RFPs) are sent to the landlords that correspond to the preferred real estate (step 735). Those landlords that are interested in meeting the needs of the would-be tenant prepare a proposal. The proposals from the various interested landlords are sent to the would-be tenant (step 740). Again, this communication of proposals may be effectuated using an on-line mechanism such as e-mail, and the information in and the layout of each proposal may be standardized in the e-mail (or its attachment(s)) to facilitate side-by-side comparisons. From these proposals, the would-be tenant selects a primary (and optionally a secondary, tertiary, etc.) real estate option (step 745). This selection may also be accomplished via e-mail.

After a would-be tenant selects at least a primary real estate option, the would-be tenant ordinarily receives an on- site (actual) tour of the selected real estate option(s), which can be efficiently scheduled using an on-line mechanism such as e-mail that is facilitated by the real estate transaction system. The would-be tenant visits, views, and appraises the selected real estate option(s). Afterwards, the would-be tenant may elect to rate and/or memorialize comments regarding the toured real estate property or properties. In accordance with certain embodiment(s) of the present invention, the would-be tenant records their ratings and comments via an on-line mechanism. For example, the would-be tenant may access a web site page that lists relevant questions for rating the toured property and/or includes blanks for entering comments. These ratings and comments are combined with those of other tenants and would-be tenants that have likewise taken tours of such respective real estate properties. The combined data (e.g., organized and amalgamated by real estate property, by landlord for services and responsiveness, etc.) may be subsequently provided to other would-be tenants, for example, during an initial searching and reviewing session, along with a listing of matching real estate, in conjunction with one or more proposals, etc.

After a would-be tenant enters a PRS (at step 705), the PRS may, instead of or in addition to being entered into a full database, be presented directly to landlords. While the PRS is preferably entered or transferred into an electronic format, multiple PRSs need not necessarily be combined into a single true database (as in step 710) in this embodiment (which focuses on steps 750 and 755). After accepting the PRS from the would be tenant, an on-line mechanism for example, presents the PRS to landlords (step 750). The PRS may be presented to all landlords that are registered by, for example, (i) posting the PRS for review by all of the landlords or (ii) sending the PRS to all landlords via, e.g., e-mail. Alternatively, relevant landlords may be ascertained using, for example, a comparison feature, and the PRS may be broadcast to these relevant landlords by e-mail, for example. The landlords that receive the PRS have the opportunity to review it and consider whether or not they have the ability to meet the specified requirements. In other words, the landlords may identify and indicate their interest in responding to the PRS (step 755). This interest may be presented through the on-line mechanism. Thereafter, entries of the interested landlords may be presented as potential matches to the would-be tenant (at step 725), or proposals from the interested landlords may be sent to the would-be tenant (at step 740).

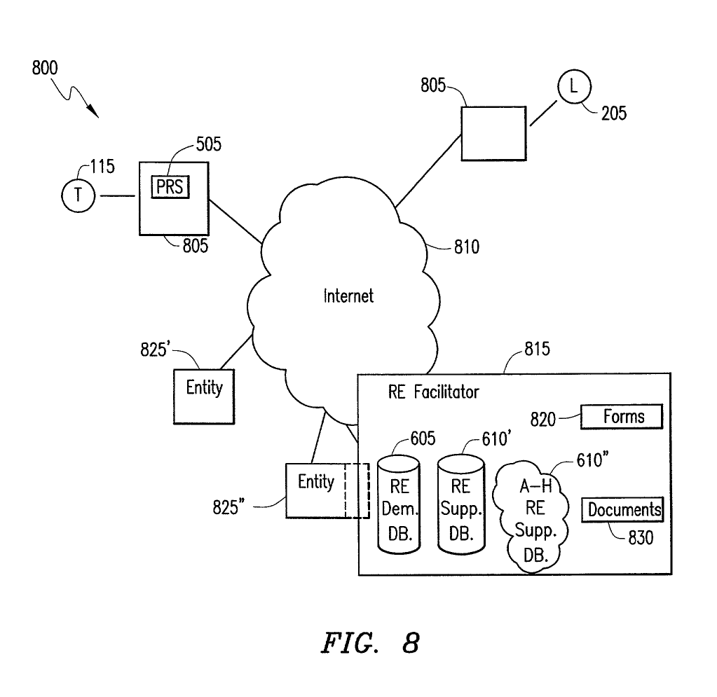

Referring now to FIG. 8, certain aspects of an exemplary on-line mechanism in accordance with the present invention are illustrated generally at 800. The exemplary on-line mechanism 800 reflects a computer network implementation in which the various participants communicate by way of the Internet 810. It should be understood, however, that other communications networks can instead be used. The would-be tenant 115 prepares a PRS 505 and inputs, transmits, or otherwise communicates the PRS 505 to the Internet 810 using a communication station 805. The communication station 805 may be, for example, a personal computer, a personal digital assistant (PDA), an e-mail enabled pager, a network server, any other device with access to the Internet 810, etc. The PRS 505 can be completed off-line and then uploaded as one file, can be completed in real-time by entering information into a form displayed on a web browser from a web site, etc.

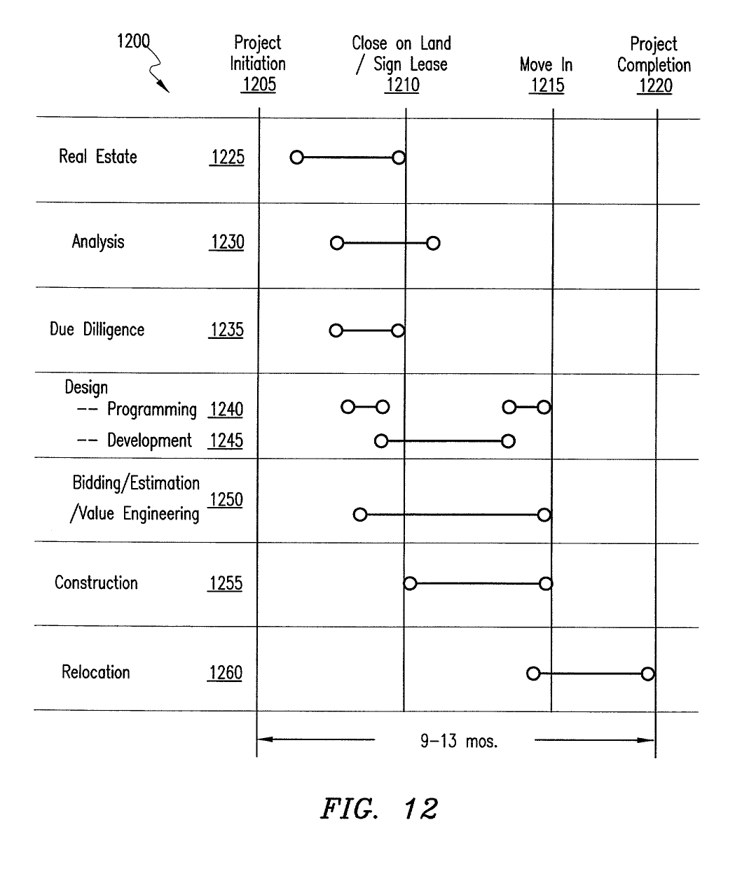

A web site transmitting the, e.g. web-enabled, form to the communication station 805 over the Internet 810 may be operated by or termed a real estate facilitator 815. The real estate facilitator 815 is responsible for creating, amending, maintaining, etc. the real estate demand database 605, the real estate supply database 610′ and the ad hoc real estate supply database 610″. These various databases may be stored in, for example, high capacity storage facilities (e.g., non-volatile memory, redundant arrays of independent disks (RAIDs), etc.) behind a protective firewall, for example. The real estate facilitator also stores and disseminates the various forms 820 for implementing the principles of the present invention. The various forms 820 may be standardized to simplify completion, review, and both manual and electronic comparisons thereof. Communications (e.g., RFPs 510 and proposals 515) to and from the landlord 205 may also be effectuated over the Internet 810 via a communication station 805. It should be understood that other electronic transmission possibilities besides electronic mail are embraced by the scope of the present invention. For example, electronic transmission may also include file transfer protocol (FTP), chat (e.g., room) technology, bulletin board posting, web page down/uploading, instant messaging, any general data/information encapsulation into an electronically-transmittable format, equivalents thereof, etc. It should be noted that two entities 825 are also illustrated as being connected to/in communication with the Internet 810. Each entity 825 may correspond to the or an important entity of one or more phases of a real estate acquisition and outfitting process, as is described further hereinbelow with reference to FIG. 12.

In addition, at least one entity 825 may support the principles of the present invention with respect to real estate subleases. The sublease entity or module serves to make available sublease space accessible to potential tenants and is therefore included in searches for available space made by would-be tenants 115 of the real estate supply database 610 (see FIG. 6). In this regard, the entries in the sublease module are treated as “virtual” buildings. In addition, the entries have easy expiration and renewal of listings.

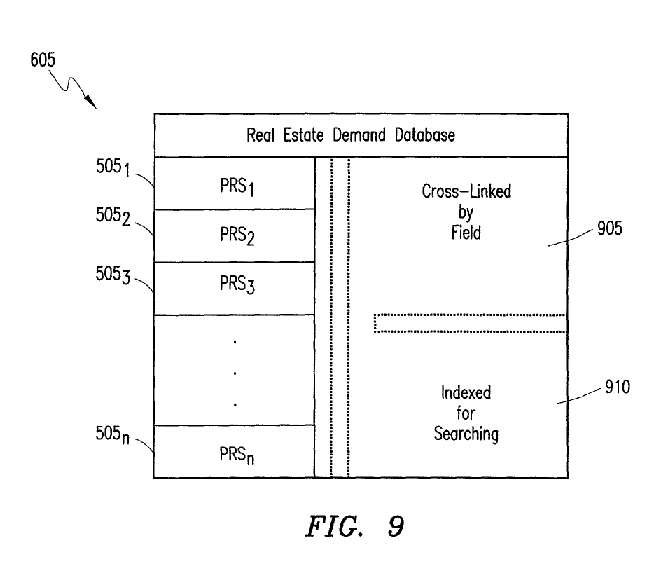

Referring now to FIG. 9, an exemplary real estate demand database in accordance with the present invention is illustrated generally at 605. The exemplary real estate demand database 605 includes multiple PRSs (PRS₁ . . . PRSₙ) 505 (505₁ . . . 505ₙ). Each PRS 505 includes information related to real estate desired by the would be tenant. For example, a PRS 505 may include (i) characteristics of the real estate, (ii) a time frame at which or by which the real estate needs to be ready for build out and/or move in, and/or (iii) desired outfitting attributes. With reference to Table 1 below, a would-be tenant may be asked the following questions in accordance with the present invention. Answers to these exemplary questions of Table 1 may constitute all or a portion of the corresponding PRS 505.

TABLE 1
Would-Be Tenant Questionnaire

| | | Question | |
|---|---|---|---|
| | Question | Type | Sample Answer |
| 1 | How much space (square | Field | 100,000 |
| | footage) is required? | entry | |
| 2 | When is the space | Date range | October - |
| | required? | | November, 2000 |
| 3 | What is the preferred | Date | October 4th 2000 |
| | move-in date? | | |
| 4 | What is the desired type | Drop-down | Warehouse/Distribution, |
| | of space? | list | Office, Medical, |
| | | | High-Tech/ |
| | | | Call Center, |
| | | | Manufacturing/Industrial, |
| | | | Educational, or |
| | | | Religious. |
| 5 | What are the geographic | Field | Dallas, Houston, |
| | parameters? | entry | Austin |
| 6 | What are the geographic | Field | Dallas - Toliway, |
| | preferences? | entry | Houston - Westheimer, |
| | | | Austin - downtown |
| 7 | What is the desired | Drop-down | Average, Above |
| | property class? | list | Average, or Premium |
| 8 | What is the desired | Field | $20/square foot |
| | rental rate? | entry | |
| 9 | What is the preferred | Field | Less than 10 stories |
| | building size? | entry | |
| 1 | Is the space expandable? | Yes/No | Yes |
| 0 | | | |
| 1 | Are there any required | Field | Would like micro- |
| 1 | special amenities? | entry | wave tower |
| | | | access on buildin roof |
| 1 | Are there any unusual | Field | Need access to T-3 |
| 2 | technical requirements? | entry | connections |
| 1 | Are there any unusualField | None | |
| 3 | configuration | entry | |
| | requirements? | | |
| 1 | Are there any needs for | Field | Need 2-3 large |
| 4 | special rooms (break or | entry | break rooms |
| | otherwise)? | | |
| 1 | What is the desired | Field | Would like 12 - 15 × 12 |
| 5 | number of offices? | entry | offices |
| 1 | What are the parking | Field | 200 spaces |
| 6 | requirements? | entry | |
| 1 | Is reserved parking | Yes/No | Yes |
| 7 | preferred? | | |
| 1 | What is the desired | Field | 3:1 |
| 8 | parking ratio? | entry | |
| 1 | What is the desired lease | Field | 10 years |
| 9 | term? | entry | |
| 2 | What is the desired lease | Drop-down | NNN, Gross, |
| 0 | type? | list | or Full Service |
| 2 | Are there any | Field | Need 1 extra acre for |
| 1 | requirements related to | entry | potential parking |
| | projected growth? | | expansion |
| 2 | Are there any programming | Field | None |
| 2 | requirements? | entry | |

The real estate demand database 605 may be merely composed of multiple PRSs 505, but in alternative embodiment(s), greater flexibility is provided by the real estate demand database 605 when related fields of different PRSs 505 are cross-linked (and/or categorized and/or organized) by field 905 to facilitate comparisons (e.g., to entries in the real estate supply database 610). Improved searching speed and effectiveness may also be established by indexing the PRSs 505 for searching 910.

Referring now to FIG. 10, an exemplary on-line mechanism for creating an ad hoc real estate supply database in accordance with the present invention is illustrated generally at 1000. A would-be tenant 115 transmits a PRS 505 (e.g., over the Internet 810) to a real estate facilitator 815 as indicated by the arrows 1005. The real estate facilitator 815, after processing the PRS 505, forwards information provided in the PRS 505 over the Internet 810 and to multiple targeted landlords 205_{1 . . . n} as indicated by the combination arrow 1010 and the separate arrows 1015_{1 . . . n}. The information included in the messages represented by the arrows 1010 and 1015_{1 . . n} indicates to the landlords 205 the presented needs (or demands) of the would-be tenant 115. Each message may list certain requirements and/or ask whether the landlord can meet them. For example, the message may ask whether the landlord will have “X” square feet available in a type “Y” building at time “Z”.

The landlords 205_{1 . . . n} formulate responses and transmit them to the real estate facilitator 815 over the Internet 810 as represented by the arrows 1020_{1 . . . n} and 1025. The responses may include those in the negative and those in the affirmative. For the latter, the response may include a listing of one or more pieces of real estate and their associated attributes for eventual consideration by the would-be tenant 115. The real estate facilitator 815 receives the responses and uses them to form an ad hoc real estate supply database 610″. This ad hoc real estate supply database 610″ is formed effectively to service the needs (demands) of the would-be tenant 115 and is tantamount to the creation of a spot market. Either individual entries or the whole of the ad hoc real estate supply database 610″ may be sent to the would-be tenant 115 for review and consideration. The principles of the present invention thereby enable the building of an ad hoc real estate supply database 610″ on a deal-by-deal basis for the creation of a quasi-spot market.

Referring now to FIG. 11, an exemplary method in flowchart form for creating an ad hoc real estate supply database in accordance with the present invention is illustrated generally at 1100. In accordance with the demand-focused scheme of certain embodiment (s) of the present invention, a would-be tenant initiates the process by completing and submitting a PRS (step 1105). A real estate facilitator processes the PRS (step 1110). The processing may entail preparing the included information for e-mailing; reformatting the included information into a format more amenable to a landlord's perspective by removing, amending, re-arranging information; extracting the most relevant information for an initial e-mailing, etc. The processed PRS is sent to multiple landlords (step 1115). The landlords analyze the requirements of the PRS in light of applicable real estate with which they are affiliated (step 1120).

Each landlord determines whether or not they are (at least potentially) able to meet the specified requirements (step 1125). If not, then the landlord may elect to respond in the negative or to not respond at all (step 1130). If, on the other hand, the landlord determines that they are possibly able to meet the specified requirements (and the landlord is interested in doing so), the landlord sends an affirmative response (step 1135). In the affirmative response or a subsequent message, the landlord sends relevant information detailing real estate that is or that will be available at the requested time to the real estate facilitator. The received real estate information from the various landlords is incorporated into an ad hoc real estate supply database (step 1140). The ad hoc real estate supply database may be used to meet the requirements stipulated in the tenant's PRS (step 1145).

Referring now to FIG. 12, an exemplary real estate acquisition and outfitting process in accordance with the present invention is illustrated generally at 1200. The time line 1200 indicates a project initiation time 1205, a close-on-land/sign-lease time 1210, a move-in time 1215, and a project completion time 1220. The duration between the project initiation time 1205 and the project completion time 1220 is typically 9-13 months when applying principles in accordance with certain embodiment(s) of the present invention. (It should be noted that the various phases in the time line 1200 are not necessarily drawn to relative scales with respect to each other.) The exemplary real estate acquisition and outfitting process time line 1200 indicates that various phases may be accomplished in parallel. For example, the real estate 1225, analysis 1230, due diligence 1235, programming design 1240, development design 1245, and bidding/estimation/value engineering 1250 phases all overlap in time to at least some extent. Furthermore, the construction phase 1255 and the relocation phase 1260 likewise overlap the bidding/estimation/value engineering 1250 phase to at least some extent.

The parallel approach to real estate acquisition and outfitting process time line 1200 indicates that multiple phases, to varying degrees and amounts, are accomplished simultaneously. While there may be increased risk, the advantages for the tenant to-be from the reduction in time to 9-13 months from project initiation 1205 to project completion 1220 justify the risk. This parallel approach is achieved, and the accompanying risks are managed and/or minimized, by using an on-line mechanism such as the exemplary on-line mechanism 800 (of FIG. 8), at least in part. The exemplary on-line mechanism 800 may also include entities 825 (e.g., builders, engineers, architects, interior designers, information technology planners, general contractors, etc.) connected to the Internet 800 (e.g., the associated with and/or part of the real estate facilitator 815 entity 825″, the separate therefrom entity 825′, etc.) that are pertinent to the completion of the phases 1230-1260. By promptly providing to them, via the on-line mechanism 800, information related to the relevant real estate transaction (e.g., the PRS 505), as well as subsequent changes thereto and/or updates thereof, phases 1230-1260 can be started while previous respective phases are still being accomplished/completed.

Changes to/for/in one phase that affect other phases, and therefore the entities pertinent thereto, may be promptly notified via the on-line mechanism 800. Furthermore, information ascertained and/or decisions made for one entity in one phase may be shared with other entities in other phases promptly. Moreover, in addition to sharing information/data via electronic point-to-point communications (e.g., e-mail), the information/data relevant to a particular real estate transaction may be posted and maintained in one location and/or by one entity (e.g., the real estate facilitator 815) for access, review, and possibly modification by other pertinent entities under appropriate security measures.

The parallel approach to the real estate acquisition and outfitting process as indicated by the time line 1200 may be enabled, at least in part, by integrating the various phases illustrated in the time line 1200 using on-line collaboration and/or document hosting. On-line collaboration between the would-be tenant, the landlord, designers, architects, contractors, cablers, brokers (if any), etc. is facilitated by sharing general project information and project schedules as well as by permitting the parties to participate in on-going dialogues together on-line. Document hosting may function as an on-line filing cabinet for documents related to the real estate acquisition and outfitting project. These documents may include, for example, the PRS 505, the RFPs 510, the proposals 515, lease documents, due diligence documents, design plans, engineering plans, construction plans, other contracts, etc. Document hosting, in certain embodiment(s), may be understood by analogizing it to providing an organized and flexible on-line filing cabinet, with the manual filing being replaced by down-loading and up-loading of documents. Preferably, all of the documents and information relating to a particular real estate transaction are associated with a “project” in the system. In this manner, the system can easily determine which items are associated with one another and/or with a particular tenant.

In accordance with one embodiment of the invention, the lease (or sale) transaction platform as provided by the real estate facilitator 815 may be coupled to a time-line (e.g., “Gant” chart)-producing module. The scheduling and other information from the lease transaction platform may be electronically (and/or automatically) ported into the time-line producing software.

Such a timeline-producing module can automatically produce an estimated schedule based on either a standard template or a “fast track” (i.e., accelerated) template. Alternatively, a schedule can be uploaded into the real estate transaction management system or can be created within the system from a blank schedule. The timeline schedule can subsequently be accessed by or provided to the various project members to keep everyone on track and to track progress toward completion. Moreover, the module can provide automatic milestone notifications to project members.

With reference again to FIG. 8, documents 830 may be stored at the RE facilitator 815 to enable access to the documents 830 to anyone with appropriate authorization. For example, the would-be tenant 115 may access the documents for its project(s) from anywhere with Internet 810 access. It should be noted that the documents 830 may alternatively be stored at another physical or logical location, including a private network, for example. These documents can include important lease documents, floor plans, images, design drawings, etc. Document hosting thus provides virtually anytime, anywhere access to the documents 830 by the would be tenant 115. The document database 830 can allow persons with appropriate security access to make revisions to documents and will track document changes by, for example, storing documents in multiple versions. Moreover, the document database 830 can keep relevant members of a project informed through “subscriptions,” wherein changed documents are automatically forwarded to appropriate project members to alert them as to the changes.

Moreover, multiple different types of documents may be used in connection with the document hosting capability of the RE facilitator 815. For example, proprietary documents, “Company Documents”, “My Documents”, and “Project Documents” may be included and organized in the Document database 830. The proprietary documents may be templates that any user(s) of the system may download and use, and “My Documents” may be personal to an individual user, while “Company Documents” may be accessible to all individuals associated with a given company in the system, and “Project Documents” may be accessible by all individuals that are associated with a particular project in the system. Notably, each set of document type(s) may be assigned a specific security level that a user must possess for that folder and document type in order to be able to access the document. Exemplary security divisions include project guest, project member, and (project) administrator. A project member may be given access to only those documents that pertain to the member's role in the project while the project administrator may have access to a larger set of documents. If a person is not part of a particular project or company, then files related to that particular project or company are inaccessible and/or are not presented to that person with the document manager. A similar setup may be instituted if a person does not have sufficient security clearance for a project, etc.

Document hosting can optionally be combined with on-line collaboration when, for example, the RE facilitator 815 permits/grants authorization to other parties to the project to view, amend, comment on, etc. one or more of the documents 830. The RE facilitator 815 can optionally grant such authorization only upon permission from the would-be tenant 115. The authorization may extend to all of the documents 830, or it may alternatively only extend to relevant documents. For example, an entity whose responsibility is limited to electrical and mechanical outfitting of the leased space may be permitted to view, amend, comment on, etc. documents such as schedules and engineering and design plans while not being granted authorization to even view the details of the actual lease agreement.

On-line collaboration thus enables multiple parties to access a document and then, optionally, do something on that document that the other parties may also view. The multiple parties are therefore working on the document together. It should be understood that parties (e.g., to a real estate acquisition and outfitting project) may collaborate on-line about other things in addition to, or instead of, documents. For example, an entity such as the RE facilitator 815 may provide an on-line project management system by which project management may be affected and effectuated by multiple parties. Thus, on-line collaboration may be practiced without requiring true document hosting.

To facilitate on-line collaboration and communications between and among the various parties to a real estate transaction or project, the real estate facilitator 815 can support pre-established communication types, via the forms database 820, for example. The pre-established communication types can include “change request,” “correspondence,” proposal history,” “RFI response history,” and “submittal.”Each communication type can include a plurality of information fields that can be used for that communication type. One or more of the fields can be designated as “required” for a particular communication type.

Among the fields of the communication types can also be an “Assign To” field. While a system in accordance with the present invention may incorporate a communication scheme in which all admitted members/enrolled participants/etc. (e.g., for a particular project) are notified of new communications (e.g., by an e-mail to their respective e-mail boxes), which they may view by logging into a web-based site, the “Assign To” enables a communication initiator to designate who has the responsibility to respond to the communication being initiated.

New communication types, in addition to those noted above, can also be defined by site users. A user might select a name for the new communication type (e.g., “Meeting Minutes”) and select from a list of default fields that can be included in the new communication type. Custom fields can also be configured after they are established in a “New Field Setup” area, which allows users to define the parameters (e.g., name/question, question type, input type, whether an answer is required, etc.) of the custom field.

Thus, the system facilitates centralized communication between project members and provides a mechanism for tracking communication history. Moreover, the communication management allows for “ball in court” tracking, which keeps project members informed when they are currently responsible for providing input, answering questions, or responding.

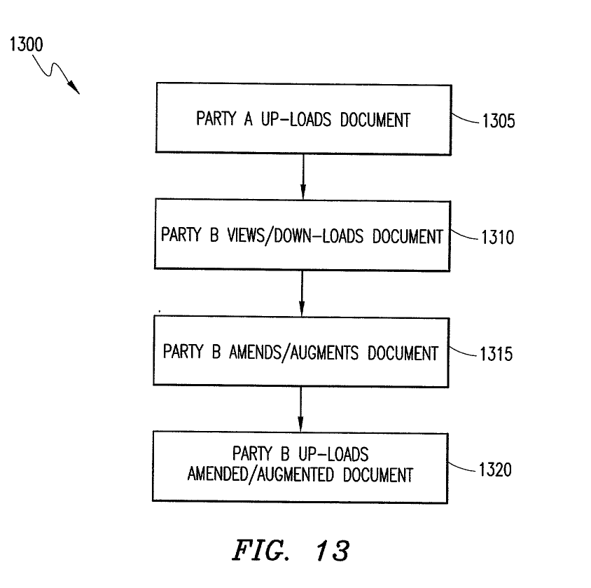

Referring now to FIG. 13, an exemplary method in flowchart form for participating in an on-line collaboration in accordance with the present invention is illustrated generally at 1300. After an RE facilitator 815 or similar entity has established a repository for documents and/or other things for which collaboration is desired, a party A up-loads a document, for example (step 1305). The document may be composed of an engineering and architectural design that the would-be tenant 115 (party A) has approved. Party B (e.g., a subcontractor charged with implementing all or a portion of the design), who procures or has procured authorization to access documents for this project of party A, views and/or down-loads the design document (step 1310). The subcontractor determines that changes need to be made. For example, the designers and engineers may have selected a particular material that is not permitted under the local codes, and the subcontractor, who is more familiar with the local codes, is able to identify this problem quickly and early. The subcontractor (party B) therefore amends/augments the design document (step 1315) by substituting the permitted material into the specifications of the design.

After amending/augmenting the design document, the party B returns the amended/augmented document to the repository by up-loading it (step 1320). The RE facilitator 815 advantageously keeps copies (e.g., a record) of all versions of all documents, schedules, etc. so that a history of the project is available for review as necessary and so that a previous version of a document may be retrieved and restored as the current version if needed. It should be noted that the RE facilitator 815 may also keep a log that links changes to documents and identifies the party responsible for the changes. As indicated by the example described above with reference to the flowchart 1300, the greater communication between the various parties of the real estate acquisition and outfitting process afforded by on-line collaboration enables the parallel approach exhibited by the programming and development design phases 1240 and 1245, the bidding/estimation/value engineering phase 1250, and the construction phase 1255 (of the time line 1200 of FIG. 12), for example.

With continuing reference to FIG. 13, with respect to step 1310, documents (or more generally files) that need special viewing software (e.g., a computer-aided drawing (CAD) viewer) may be down-loaded along with the document. With respect to step 1320, party B may optionally have the ability to elect to notify other (e.g., relevant) parties to the project that a document has been amended/augmented. For example, all parties may be notified by, for example, e-mail. Alternatively, only those parties affected by the changes (e.g., the would-be tenant, the landlord, the engineers and architectural designers in the above-described example) may be contacted.

In general with regard to on-line collaboration, communications between and among parties to a project may be launched from a, e.g., web site of the RE facilitator. Such communications may be tracked throughout the life of the communication as different communication threads of the project. When communications are started or added to (or when files are amended/augmented), at least three options may be implemented with respect to “notifying” other project parties. For example, it may be required that each interested party must access the on-line mechanism to be informed of the changes. Alternatively, all or relevant parties may be notified via an electronic transmission. The electronic transmission may notify the recipient that changes have occurred to the project, may notify the recipient that specific files have been changed, may notify the recipient of the actual changes, etc.

On-line collaboration thus enables a pro-active integration of the various phases (and the relevant parties of the various phases) of the time line 1200 (of FIG. 12) from beginning the leasing process (e.g., the project initiation 1205) to the final move-in (e.g., the project completion 1220). Communication and information exchange is tracked and made visible; changes (e.g., change orders) are posted and reviewable/approvable by relevant parties. The on-line collaboration can serve as a project bulletin board to record past and on-going interactions, comments, discussions, etc. On-line collaboration in conjunction with document hosting enables the storing and collaboration of documents and other files. The on-line collaboration, with or without document hosting, can be instrumental (while not necessary in all embodiment (s)) in providing a seamless integration and flow between the various phases of the time line 1200.

Embodiment(s) of the on-line mechanism in accordance with the present invention advantageously facilitate the parallel progression of the project through the various phases 1225-1260 by sharing access and the ability to modify project files. The progression of the time line 1200 from project initiation 1205 to project completion 1220 is further expedited by sharing particular data from one phase to a subsequent (or preceding) phase. For example, certain information, some of which is collected during the real estate phase 1225 (and perhaps with the initial PRS 505), may be shared and/or forwarded to one or more parties that are wholly or primarily involved in a phase subsequent to the phase in which the information is collected. The following data, in any combination, is exemplary of such information that may be shared/forwarded to other phases in the time line 1200: (1) project name, description, start date and required move-in date; (2) (would-be) tenant name and other info; (3) property address, square footage, age, floor number(s), number of floors, parking requirements, pictures and images of the interior and exterior of the building; (4) proposal financial data including lease term, rent, etc.; (5) lease agreement and letter of intent documents; (6) project schedule; (7) project member information (names of members of the projects such as the general manager/general contractor, subcontractors, brokers, design firm(s), etc.); etc. At least the majority of this information is determined and attained during the real estate phase 1225, and it may advantageously be passed on to parties involved entirely or primarily in other phases 1230 to 1260 of the time line 1200 via an on-line mechanism, including an on-line collaboration.

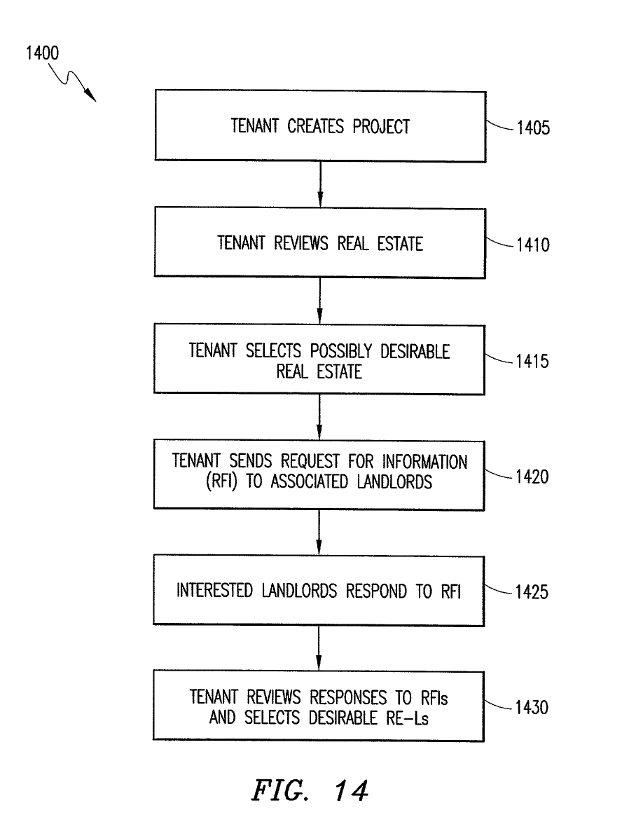

Referring now to FIG. 14, an exemplary method in flowchart form of an alternative embodiment for creating an ad hoc real estate supply database in accordance with the present invention is illustrated generally at 1400. The flowchart 1100 (of FIG. 11) addresses tenant submission of a PRS (at step 1105), processing of the PRS (at step 1110), and sending of the PRS to multiple landlords (at step 1115). The flowchart 1400 illustrates an alternative for selecting which landlords are sent the PRS. When a would-be tenant accesses the, e.g., web site of the RE facilitator for the first time for a given leasing need and/or situation, the would-be tenant creates a project (step 1405). The would-be tenant, knowing certain minimum requirements or expectations such as desired area of town, building type, etc., reviews a listing of buildings (or, more generally, real estate) that might meet the would-be tenant's requirements and/or expectations (step 1410). This real estate listing is advantageously easily maintained by the RE facilitator inasmuch as buildings rarely are built, are demolished, or have their ownership/management information changed, at least as compared to the frequency at which portions thereof become available or unavailable for lease.

From the listing of real estate, the would-be tenant selects one or more (or even all) of the reviewed real estate as possibly desirable real estate (step 1415). The would-be tenant may thereafter send a request for information (RFI) to each landlord associated with the selected real estate (step 1420). As compared to a PRS or RFP, an RFI includes significantly less information. For example, an RFI may primarily include the desired move-in date and the desired square footage (whereas an RFP includes significantly more, e.g., financial information). From this minimal information, the landlords that are interested in pursuing this real estate demand further respond in the affirmative to the RFI (step 1425) with the requested information (e.g., amount of square footage available at a certain date or dates). The would-be tenant can then review the responses to the RFIs and select the real estate (and associated landlords) that still appear to be desirable (step 1430). These selected pieces of real estate may be considered in combination as an ad hoc potential real estate supply database. It should be noted that the communications corresponding to the steps of the flowchart 1400 may be effectuated in whole or in part via an electronic transmission.

A communication/negotiation exchange preferably uses communication screens, which may be accessed using, for example, a browser or other thin-client. The communication screens provide input areas for the user to enter text, including questions, responses, and comments. Notably, a previous piece of relevant information (including a question) is repeated for the convenience of the would-be respondent. The respondent can easily see the context and previous precipitant of the relevant information, as well as enter a response and/or comment in provided area(s) because the previous response(s)/question(s) appear along side, or otherwise in proximity to, the current issue(s)/question(s). In these (and other) manners, a history of the RFI and/or RFP exchanges and dialogues or other communications may be logged, recorded, and subsequently noted. Moreover, the use of “ball in court” tracking, as discussed above, facilitates prompt responses and convenient monitoring of communication exchanges.

As an example, a communication/negotiation exchange could involve a Request for Information (RFI) dialogue between a potential tenant and a landlord. Once the potential tenant receives a response to the RFI, the potential tenant can then be given the option to comment on or request clarification or additional information relating to the response. Preferably, the potential tenant is presented with each original question in the RFI, the landlord's corresponding response, and a space or field in which to insert a comment or additional related question to be sent to the landlord. If the landlord elects to respond to the comments or additional questions, the landlord is likewise presented with the entire dialogue that has occurred with regard to each initial question.

As alluded to hereinabove, the real estate listing that the would-be tenant reviews (at step 1410) may be from a database that is created and then maintained by a RE facilitator with relative ease. For example, while the RE facilitator preferably knows of the existence of every (e.g., commercially leasing) building in a given geographic region, the RE facilitator need not create, much less maintain an updated, database of specific square footage blocks available within the buildings. Not only is the amount of information of the database significantly reduced (e.g., by a factor of approximately 20), the information therein also changes significantly less frequently. It should be understood that the RFI alternative embodiment as described hereinabove with reference to FIG. 14 is optional. However, it advantageously improves the workload management of the real estate participants of the on-line mechanism as well as increasing the “realness” of the deal, thus improving participation for any given deal. It is possible, for example, that real tours may be elected to be taken before RFPs are sent out.

In accordance with one aspect of the present invention, a user may customize many/all of the forms 820 (see FIG. 8) available for use in the real estate transaction process. Customized form building can be used, for example, to generate RFIs and Request for Proposals (RFPs). An RFI or RFP can be generated from a list of required questions (e.g., available space in square feet, available move-in date, etc.), selected optional questions, and custom questions (i.e., user generated question based on specific space needs, such as general office space or technology space). Thus, an RFI or RFP that is entirely customized for the particular potential tenant, real estate transaction, and/or building can be conveniently generated and sent to one or more landlords that have been identified as having real estate that potentially meets the tenant's needs. Such customized RFIs and RFPs can also be saved for reuse. For example, a company might generate customized RFIs and RFPs by region (e.g., Southwest) or group (e.g., sales group) that can be saved and used as a customized template for future real estate transactions.

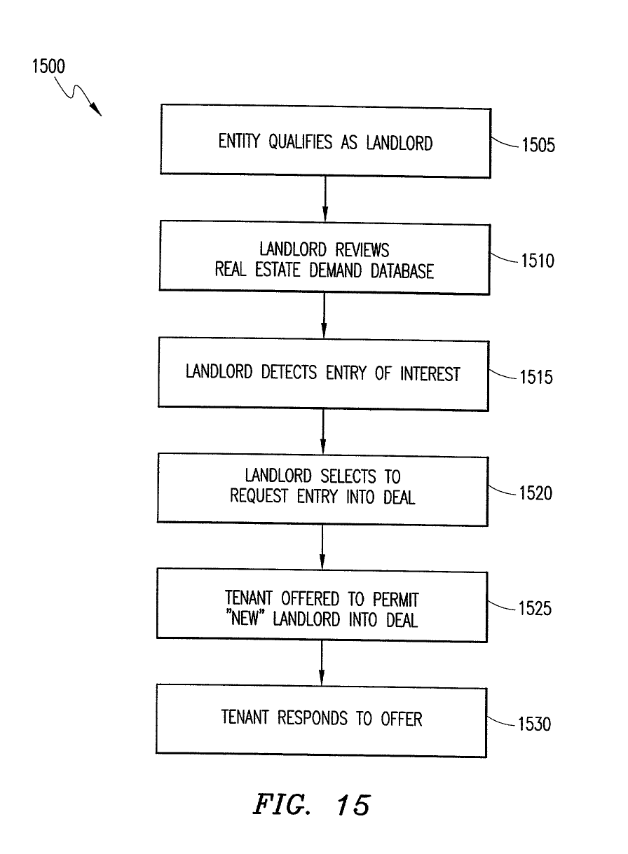

Referring now to FIG. 15, an exemplary method in flowchart form of an alternative embodiment for linking tenants to real estate in accordance with the present invention is illustrated generally at 1500. The flowchart 700A and 700B (of FIGS. 7A and 7B) addresses landlord review of entries in a real estate demand database (at step 750), landlord identification and indication of interest of one or more entries (at step 755), and landlord instigation of a presentation of interest to the would-be tenant (at step 725). (See also the searching/viewing arrow 625 (of FIG. 6) and related text.) The flowchart 1500 illustrates an alternative for how and when a landlord indicates such interest. Initially, an entity qualifies as a landlord (step 1505) with the on-line mechanism. The entity may qualify as a landlord by providing information regarding real estate holdings possessed by the entity.

This real estate information is especially valuable if it pertains to currently available real estate. Regardless, the information may be a valuable addition to any real estate listing maintained by the RE facilitator for eventual review and consideration by a would-be tenant. Instead of needing to spend time and money to collect information on every piece of real estate in a given geographic area, landlords themselves are prompted and encouraged (as well as required at least to gain initial entry) to provide information on their possessed real estate holdings. To gain access to the real estate demand (aggregation) database, landlords may therefore be required to contribute to the real estate supply database. This contribution requirement also serves to provide a measure of security and privacy for the real estate demand (aggregation) database by instituting an authorization access privilege therefor, with the authorization access privilege being established such that it may be met by owners/managers of real estate. After the entity is qualified as a landlord (at step 1505), the landlord may review the real estate demand (aggregation) database (step 1510).

The landlord may review the real estate demand database entry-by-entry or after narrowing the total number of entries by, e.g., limiting the entries (e.g., via a search or organized category selection) according to square footage, geography, move-in date, etc. The landlord may review entries (e.g., a PRS, RFIs, RFI responses, etc.) corresponding to projects that are still beginning or even projects for which RFIs have been sent out. (Landlords may optionally be given the opportunity to review project/deals that are further along.) It should be noted that the would-be tenants (or other project participants) may elect to have their privacy maintained by having their name/identification withheld and/or hidden from review by landlords or other third parties that have been granted authorization to review entries. When the landlord detects an entry of interest (step 1515), the landlord can select to request entry into the deal/project (step 1520). For example, the landlord (in a web-based embodiment) may be able to click on a web page “button” that reads “Get Me in This Deal”, or similar.

The landlords request to have an opportunity to enter the deal (at step 1520) is honored by offering the tenant the option to permit this “new”, or additional, landlord to enter the deal (step 1525). This offer may take the form of, for example, the sending to the would-be tenant (who may still be unidentified) of an unsolicited response to the initial RFI through the on-line mechanism of the RE facilitator. The would-be tenant may optionally be given the opportunity to prevent such opt-in requests from additional landlords or even the opportunity to prevent its project/deal from being presented to landlords reviewing the real estate demand database. After receiving the unsolicited RFI “response” (at step 1525), the would-be tenant may respond to the offer by either excluding the “new” landlord or including the “new” landlord. If the would-be tenant elects to include the RFI “response”, the “new” landlord may be entered into an ad hoc potential real estate supply database and/or may proceed to prepare a proposal.

Landlords are thus offered access to the real estate demand (aggregation) database to peruse specifications, deal status, etc. Landlords can consequently “throw their hat into the ring” by submitting information covering real estate that they have to offer to the would-be tenant. This aspect of the present invention beneficially further exposes relevant information to real estate market participants, which therefore more closely emulates a market in which perfect information is available.

In addition, instead of having to perform manual searches, an automated agent for a landlord may be established to search for potential tenant(s) in the real estate demand database of the system. For example, a “Current Demand Agent” may be established to regularly search for real estate needs of a predetermined size(s) at a predetermined date(s) in a give market. In other words, a landlord can cause the demand database to be searched at regular intervals with or without reports being generated for each search (e.g, only if a successful match found, regardless, etc.).

The demand aggregation functionality described hereinabove with reference to, for example, the real estate demand database 605 (of FIGS. 6, 8, and 9), the step 710 (of FIG. 7A), and step 1510 (of FIG. 15), is described primarily, but not exclusively, in terms of current demand or “near-term” future demand. However, applying “long-term” future demand to the (other) principles of the present invention is also advantageous. For example, a current tenant may cause to be posted (e.g., by adding to the real estate demand (aggregation) database) particulars of a current lease. The posting may stipulate that the current tenant “W” has a lease of “X” square feet in region/area “Y” expiring at date “Z”. Landlords are therefore empowered to search/view “long-term” demand by perusing these currently-in-effect contracts. Again, the landlord access may be straightforward, may be based on key term searches, may be based on selection of an organization category, may be in conjunction with current and “near-term” accessing, etc.

The current tenant “W” may therefore enjoy (e.g., welcome and/or invite) unsolicited bids for meeting the tenant “W”'s real estate, e.g., leasing needs upon expiration of its current contract. Thus, current tenants can post the particulars of their current real estate situation, including details of their current lease, if desired. The term “current real estate situation” in this context may embrace the inclusion and/or consideration of “long-term” future demand entry or entries, at least by inference. The tenant “W” may optionally elect to remain anonymous and to merely post non-identifying details of its current real estate situation. The tenant “WI” may also be given the opportunity (e.g., by the RE facilitator) to stipulate who is permitted to access its current real estate situation. This stipulation may take the form of, for example, the barring of particular individual landlords, the barring of particular categories of landlords, event-by-event election as to whether the identity of the tenant “W” is to be revealed to a given interested landlord (e.g., by e-mail inquiry to the tenant “W” whenever a landlord indicates interest in an anonymous current real estate situation entry), etc.

Alternatively, the RE facilitator may determine which landlords are given access based on, e.g., a tiered or privileged delineation, with various levels assigned based on financial remuneration from a landlord, the extent to which the landlord uses (e.g., completes a real estate transaction over) the on-line mechanism, the frequency with which the landlord updates its associated entries in the real estate supply database, etc. It should be noted that landlords may submit for inclusion in a real estate supply database, for posting, etc. the real estate agreements to which they are a party. Ultimately, the on-line mechanism may produce for viewing/searching access a “long-term” real estate demand from tenants as well as a “long-term” real estate supply from landlords. Such real estate supply and demand information may be consequently exposed and laid open to the myriad of participants in the real estate marketplace. If a tenant “W” elects to submit (e.g., for posting) most or all of its current leases (e.g., the entirety of its real estate situation), then the on-line mechanism can serve as a window to the real estate portfolio of the given tenant

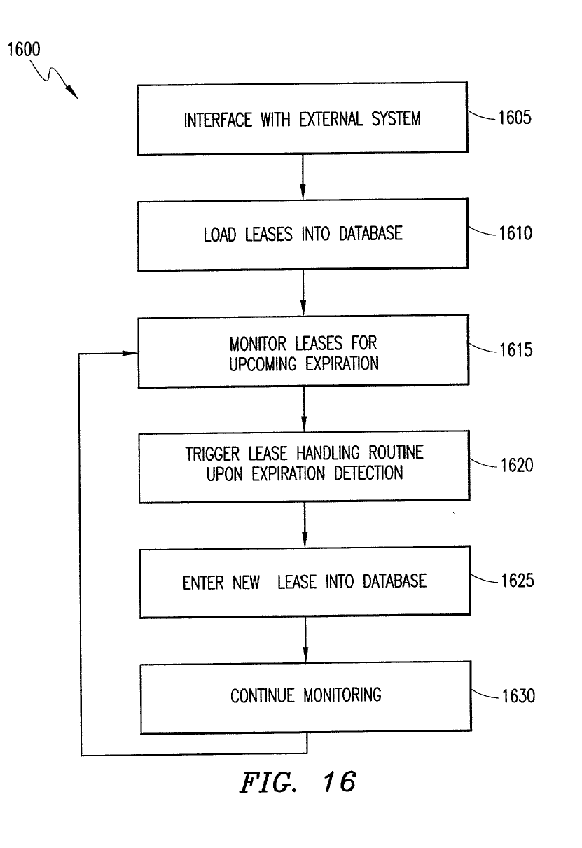

Referring now to FIG. 16, an exemplary method in flowchart form for lease administration in accordance with the present invention is illustrated generally at 1600. Many tenants (and landlords) have such an extensive real estate portfolio that it becomes difficult to manage and plan for renewing or otherwise handling the expiration of each lease. The on-line mechanism of certain embodiment (s) of the present invention can be advantageously employed to help with lease administration. Optionally but preferably, software that is part of, or that is merely operationally interactive with, software running all or parts of an on-line mechanism in accordance with the present invention is adapted to interface with the lease administration software of a client (e.g., a tenant or landlord). The software of the on-line mechanism can therefore interface with the external system of the client (step 1605). Using the optional interface, or another form of input such as a manual entry, the leases of the client are loaded into a database (step 1610).

The database may be, for example, a separate database that only stores leases for lease administration and perhaps for only an individual client/individual client situation. Alternatively, the database may be part of a larger real estate demand (aggregation) database, with each entry tagged as also being part of a lease administration sub-database. Regardless, the leases that have been loaded into the database are monitored for upcoming expiration (step 1615), e.g., by extracting the lease expiration date and other pertinent information such as the number of square feet leased, monthly lease amount, etc. While the leases are being monitored, they may be optionally entered as “long-term” demand entries. Alternatively, a real estate demand entry may only be entered as a given current lease nears expiration. Once a given lease has been detected as expiring in the near-term or immediate future, a lease handling routine is triggered (step 1620).

The lease handling routine may entail, for example, attempting to renegotiate the current lease (for either a tenant client or a landlord client), entering relevant information from the lease into a real estate demand (aggregation) database (for a tenant client), having the tenant client produce a new PRS, entering relevant information from the lease into a real estate supply database (for a landlord client), having the landlord client produce/enter new information for a new real estate supply database entry, etc. It should be noted that “near-term” may correspond to, for example, a period of one year or less. However, this period is illustrative only because “near-term”! may depend on the complexity involved for the tenant client to be able to move to a new location (with accompanying outfitting, etc.), if desired. Also, in this context, entering an entry into a database may correspond merely to activating the entry as being available for searching/viewing access (including comparison access).

After the lease handling routine (of step 1620) is completed and a new lease is executed, the new lease is entered into the database (step 1625). The monitoring may be continued (step 1630) until another upcoming lease expiration is detected (at step 1615). It should be noted that the new lease may also be forwarded to the lease administration software of the client using an established interface. It should be emphasized that while lease administration is beneficial for tenant clients (who may have hundreds or more leases for monitoring), it is also beneficial for landlord clients, who may have thousands of leases in a single building alone. These leases may also be beneficially tracked/monitored with the landlord being informed when a lease is due to be terminated. Lease administration embodiment (s) may therefore provide a seamless integration of leases currently in effect (e.g., via a client's lease administration system and/or software) with acquisition of a new lease via an on-line real estate mechanism.

In other embodiment(s) in accordance with the present invention, information regarding a current project/deal may be provided to entities (e.g., entities 825) in exchange for value. The entities may include vendors who profit from real estate moves/transactions and are relevant to one or more of the phases 1225-1260 (of FIG. 12), such as IT installers, movers, etc. The information (e.g., access to the deal flow as tracked by the on-line mechanism, with or without on-line collaboration) may be exchanged for referrals, financial remuneration, or other value. The entities may also be given the opportunity/authorization to send an electronic transmission to a would-be tenant of a project/deal bidding on or offering to bid on the provision of goods or service in the project/deal. The would-be tenant may accept or refuse such bids or offers to bid, and the would-be tenant may also be given the option of preventing access to its project/deal by such third party suppliers. These embodiment(s) may entail selling information during a project/deal/transaction to vendors.

However, in other embodiment(s) in accordance with the present invention, information regarding past projects/deals/transactions may be provided to entities. Information regarding past projects/deals/transactions may be (e.g., statistically) tracked and trended, and this “research” information may be exchanged for value. After extracting and combining information from multiple projects/deals/transactions that have been effectuated through the on-line mechanism, the summary transaction data may be sold or otherwise exchanged for value with interested parties, such as developers, lenders, appraisers, etc. Updated summary transaction data information may be provided, for example, via an electronic transmission and, optionally, at regular intervals. The trended data may include, for example: (1) average lease rates per building; (2) average time length for deals to be completed; (3) average number of bidders per deal; (4) average number of participants of the on-line mechanism; (5) ranking of buildings', lease rates, parking options, tenant improvement allowances, etc.; etc.

In still other embodiment(s) in accordance with the present invention, real estate agreements may be provided via an on-line mechanism. These real estate agreements may include real estate lease contracts, for example, and they may be stored at the RE facilitator 815 (of FIG. 8) (e.g., under the forms 820). Parties to real estate agreements, which may cover any contract between parties in any of the various phases 1225-1260 (of FIG. 12), may separately or jointly create or build a contract on-line by electing to select or delete standard clauses, sections, and/or addendums that are provided by the RE facilitator. This contract creation/building may be effectuated in real-time or non-real-time in an on-line collaborative environment. The trending aspects of certain embodiment(s) of the present invention as described hereinabove may be advantageously used to track which clauses, section, and/or addendums are selected most frequently, are selected by particular industries, are selected for particular types of real estate, etc. The statistical information derived from this tracking may be applied to gradually develop “neutral” agreements and/or to gradually further refine the standard agreements previously provided by the on-line mechanism.

The various embodiments of the present invention thus place the tenant customer in the center of the real estate transaction and enable a demand-focused scheme and an on-line mechanism that further permits a parallel approach to the real estate acquisition and outfitting process. The demand aggregation and ad hoc real estate supply database aspects of certain embodiment(s) of the present invention therefore facilitate the empowerment of the tenant customer by the real estate industry.

Although preferred embodiment(s) of the methods, systems, and arrangements of the present invention have been illustrated in the accompanying Drawings and described in the foregoing Detailed Description, it will be understood that the present invention is not limited to the embodiment(s) disclosed, but is capable of numerous rearrangements, modifications, and substitutions without departing from the spirit and scope of the present invention as set forth and defined by the following claims.

What is claimed is:

1. A system for instituting a tenant-centric paradigm in the real estate industry, comprising:
a network, said network adapted for enabling communication by at least one prospective tenant and a plurality of landlords;
a real estate facilitator, said real estate facilitator connected to said network and capable of communicating with the at least one prospective tenant and the plurality of landlords via said network, said real estate facilitator including a real estate supply database; and
wherein said network and said real estate facilitator empower the at least one prospective tenant to select a piece of real estate from a collection of pieces of real estate, said collection formed from the real estate supply database responsive to at least one desired characteristic of real estate.

2. The system of claim 1, wherein said real estate facilitator further includes a document database for electronically storing documents for use in connection with a real estate transaction.

3. The system of claim 2, wherein said document database indexes documents according to at least one of a real estate project, a company, and a user.

4. The system of claim 1, wherein the real estate facilitator supports a plurality of pre-established communication types for use in performing communications between the at least one prospective tenant and the plurality of landlords, each pre-established communication type having at least one associated information field.

5. The system of claim 4, wherein the real estate facilitator tracks which of said at least one prospective tenant and said plurality of landlords is responsible for responding to a communication initiated using one of said pre-established communication tyeps.

6. The system of claim 1, wherein the real estate facilitator further includes a forms database for generating electronic forms that include at least one entry from a pre-established list of available entries and at least one customized entry.

7. A method for linking real estate with tenants, comprising the steps of:
submitting, by a prospective tenant, information specifying desired real estate;
providing a building database, the building database including a plurality of entries, each entry of said plurality of entries corresponding to information relating to real estate regardless of whether the real estate is known to be or is scheduled to be available;
comparing the information specifying desired real estate to the building database; and
determining one or more matches between the information specifying desired real estate and the plurality of entries of the building database.

8. The method in accordance with claim 7, further comprising the step of:
presenting the one or more matches to the prospective tenant.

9. The method in accordance with claim 8, wherein said step of presenting the one or more matches to the prospective tenant further comprises the step of:
presenting the one or more matches to the prospective tenant in a standardized format using an online mechanism.

10. The method in accordance with claim 8, further comprising the step of:
selecting, by the prospective tenant, at least one preferred match of the one or more matches for which to request a proposal.

11. The method in accordance with claim 10, further comprising the step of:
sending a request for a proposal to each landlord corresponding to each match of the at least one preferred match.

12. The method in accordance with claim 11, further comprising the steps of:
sending a proposal from each of at least one landlord to the prospective tenant; and
selecting, by the prospective tenant, a primary proposal and a secondary proposal for further consideration.

13. The method in accordance with claim 7, further comprising the step of:
presenting the information specifying desired real estate to a plurality of landlords.

14. The method in accordance with claim 13, wherein said step of presenting the information specifying desired real estate to a plurality of landlords further comprises the step of:
sending or broadcasting the information specifying desired real estate to one or more landlords, each landlord of the one or more landlords corresponding to real estate that corresponds to an entry in a real estate supply database that matches the information specifying desired real estate.

15. The method in accordance with claim 7, wherein the information specifying desired real estate comprises a project requirements specification.

16. The method in accordance with claim 15, wherein the project requirements specification comprises characteristics defining desired real estate traits and date information defining a desired access and/or move-in time or time period.

17. A method for creating a quasi-spot market in real estate, comprising the steps of:
receiving at least one desired attribute for real estate from a prospective tenant;
processing the at least one desired attribute for real estate to produce a processed at least one desired attribute for real estate;
providing the processed at least one desired attribute for real estate to a plurality of landlords;
receiving a plurality of messages from at least a portion of the plurality of landlords, each message of the plurality of messages including at least one attribute for available real estate of a respective landlord of the at least a portion of the plurality of landlords; and
presenting the plurality of messages to the prospective tenant via an online mechanism.

18. The method in accordance with claim 17, wherein said step of providing the processed at least one desired attribute for real estate to a plurality of landlords comprises the step of providing the processed at least one desired attribute for real estate to a plurality of landlords via electronic mail.

19. A method for servicing a real estate transaction, comprising the steps of:
aggregating demand-specific real estate supply into a database, the database including a plurality of entries, each entry of the plurality of entries formed responsive to at least one desired real estate attribute provided by a prospective tenant;
providing at least one entry of the plurality of entries to the prospective tenant; and
submitting, by the prospective tenant, at least one request for information, each request for information relating to at least one entry of the plurality of entries.

20. The method in accordance with claim 19, further comprising the step of:
transmitting each request for information to a landlord that corresponds to each of the at least one entry via an electronic transmission.

21. The method of claim 20, further comprising the steps of:
receiving, from at least one landlord a response to the request for information; and
presenting said response to the prospective tenant.

22. The method of claim 21, wherein said step of presenting said response to the prospective tenant includes presenting each item in said response together with an entry to which the item was responsive.

23. A method for providing real estate acquisition and outfitting services to a prospective tenant, comprising the steps of:
providing real estate acquisition service using an online mechanism;
providing at least one real estate outfitting service selected from the group comprising analysis, due diligence, programming design, development design, and bidding/estimation/value engineering using an online mechanism; and
wherein said step of providing at least one real estate outfitting service is performed, at least in part, by using information acquired during said step of providing real estate acquisition service.

24. The method of claim 23, further comprising the step of automatically generating an estimated schedule relating to the real estate acquisition service and the at least one real estate outfitting service.

25. The method in accordance with claim 23, wherein the on-line mechanism comprises a web site that facilitates at least one of organizing, updating, exchanging, and sharing of information used to provide the real estate acquisition and outfitting services to the prospective tenant.

26. A method for determining potential interest in meeting a real estate need, comprising the steps of:
reviewing, by a prospective tenant, a list of real estate;
selecting, by the prospective tenant, real estate that meets at least one preliminary criterion via an online mechanism;
sending, by the prospective tenant, a request for information (RFI) to landlords associated with the selected real estate via an electronic communication;
sending, by each landlord interested in a real estate transaction that corresponds to the RFI, a response to the RFI via an electronic communication;
receiving a plurality of responses to the RFI; and
reviewing, by the prospective tenant, the plurality of responses to the RFI via said online mechanism.

27. The method in accordance with claim 26, further comprising the steps of:
creating, by a prospective tenant, a real estate project;
selecting a subset of the plurality of responses to the RFI for further consideration; and
associating said subset with said project.

28. The method of claim 26, wherein said list of real estate includes information on at least one sublease electronically stored in a database of available subleases.
